(19) United States
(12) Patent Application Publication
(10) Pub. No.: US 2007/0178043 A1
(43) Pub. Date: Aug. 2, 2007

(54) Sliding material, manufacturing method therefor, and device employing sliding material

(75) Inventor: Kouji Miura, Tajimi-shi (JP)

Correspondence Address: GROSSMAN, TUCKER, PERREAULT & PFLEGER, PLLC, 55 SOUTH COMMERICAL STREET, MANCHESTER, NH, 03101, US

(73) Assignees: SEIKO INSTRUMENTS INC., Chiba-ken (JP); AICHI UNIVERSITY OF EDUCATION, Aichi-ken (JP)

(21) Appl. No.: 11/570,164

(22) PCT Filed: Dec. 3, 2004
(86) PCT No.: PCT/JP04/18016

§ 371 Date: Dec. 7, 2006

(51) Int. Cl. C01B 39/00

(52) U.S. Cl. 423/705

(57) ABSTRACT

The sliding material of the present invention has hexagonal crystals that form a layer structure and ball-shaped molecules inserted in interlayers of the hexagonal crystals. This sliding material can be used in machines/devices of various sizes ranging from heavy machinery such as automobiles to nanomachines without restrictions on the environment it can be used, can minimize friction compared to conventional types, and has superior durability.

### TECHNICAL FIELD

The present invention relates to a sliding material, a manufacturing method therefor and a device employing the slide material.

### BACKGROUND ART

Lubricants (sliding materials) that reduce friction between bodies have transitioned from solid lubricants to fluid lubricants. However, since the use of fluid lubricants is restricted in environments where fluids cannot be used such as vacuums and high temperature environments, problems arise such as insufficient reduction in frictional force and low durability. Also, with the appearance of tiny machinery such as micromachines and nanomachines, the development of a lubricant and lubrication system that can be used even in tiny machinery is eagerly awaited.

As a lubrication system applicable to tiny machinery, a lubrication system has been proposed that sandwiches carbon ball molecules or carbon tube molecules between graphite substrates (Patent Document 1). In this lubrication system, C₆₀ molecules are vapor-deposited on a graphite substrate surface to form a monolayer C₆₀ molecular film. By utilizing the rolling of the C₆₀ molecules, a separate graphite substrate that is placed on the C₆₀ molecular film can be made to slide.

However, in the case of forming a C₆₀ molecular film by vapor-deposition, regulating the C₆₀ molecular film formed on the graphite substrate surface to a monolayer is difficult, and it is easy in practice for the C₆₀ molecules to overlap over two layers. When a bi-layer C₆₀ molecular film is formed, rolling of the C₆₀ molecules is hindered, which increases the friction between the two graphite substrates. Fabrication by the vapor-deposition method of a lubrication system that can minimize friction between graphite substrates has involved such difficulties. Also, the durability of the lubrication system that sandwiches carbon ball molecules or carbon tube molecules between graphite substrates is not sufficiently satisfactory.

[Patent Document 1] Japanese Unexamined Patent Application, First Publication No. 2003-62799.

### DISCLOSURE OF THE INVENTION

Problem to be Solved by the Invention

The object of the present invention is to provide a sliding material that can be used in machines/devices of various sizes ranging from heavy machinery such as automobiles to nanomachines without restrictions on the environment it can be used, can minimize friction compared to conventional types, and has superior durability; a method of manufacture that can readily manufacture the sliding material; and a device that uses the sliding material.

Expedient for Solving the Problem

The sliding material of a present invention is characterized by having hexagonal crystals that form a layer structure and ball-shaped molecules inserted in interlayers of the hexagonal crystals.

The structure in which ball-shaped molecules are inserted in interlayers of the hexagonal crystals preferably exists in plurality repetition in the thickness direction.

The ball-shaped molecules preferably form a monolayer in each interlayer of the hexagonal crystals.

The ball-shaped molecules preferably have five-member rings or six-member rings of carbon.

The distance between ball-shaped molecules in the thickness direction is preferably 1.4 nanometers or less.

Also, the sliding material of the present invention may be a mixture of the sliding material and a solid or fluid, and may be one provided on a solid surface.

The method of manufacturing the sliding material of the present invention is characterized by having a step that widens the interlayer of hexagonal crystals forming a layer structure and a step that inserts ball-shaped molecules in the interlayer of the hexagonal crystals.

In the manufacturing method, it is preferable to insert the ball-shaped molecules in the interlayer of the hexagonal crystals by sublimating the ball-shaped molecules.

The device of the present invention is characterized by having a sliding portion in which at least one member slides with respect to another member, and being provided with the sliding material of the present invention on the surface of at least one member of the sliding portion.

A timepiece of the present invention is a timepiece having at least one set of gears that transmits power and a changeover mechanism that corrects the time, characterized by the gears and/or the changeover mechanism having a sliding portion in which at least one member slides with respect to another member and being provided with the sliding material of the present invention on the surface of at least one member of the sliding portion.

The motor of the present invention is characterized by having a sliding portion in which at least one member slides with respect to another member, and being provided with the sliding material of the present invention on the surface of at least one member of the sliding portion.

Effect of the Invention

The sliding material of the present invention can be used in machines/devices of various sizes ranging from heavy machinery such as automobiles to nanomachines without restrictions on the environment it can be used, is highly effective in reducing friction compared to conventional types, and has superior durability.

The sliding material of the present invention can be readily manufactured according to the manufacturing method for the sliding material of the present invention.

The device, timepiece, and motor of the present invention can minimize friction in the sliding portion and can maintain the low friction state for a long period.

### BEST MODE FOR CARRYING OUT THE INVENTION

(Sliding Material)

The sliding material of the present invention is an intercalation compound having hexagonal crystals that form a layer structure and ball-shaped molecules inserted (intercalated) in the interlayers of the hexagonal crystals. The structure of the ball-shaped molecules inserted in the interlayers of the hexagonal crystals preferably exists in multiple repetition in the thickness direction.

Specific examples of the hexagonal crystal forming a layer structure include graphite and molybdenum disulfide, and the like, with graphite being preferred. The graphite has a layer structure in which a large number of planar layers of connected six-member rings of carbon atoms are overlapped. The graphite shape may be suitably selected in accordance with the use of the sliding material, with examples including a film shape and powder shape.

Since the ball-shaped molecules are required to have a strong interaction with the graphite, those having five-member rings or six-member rings of carbon are preferred. Also, since the ball-shaped molecules are required to easily enter the graphite interlayer and be stable, those having a diameter of 0.7 nanometer or more and 0.8 nanometer or less are preferred.

Fullerenes are particularly preferred as the ball-shaped molecules. Fullerenes are hollow, shell-shaped carbon ball molecules closed by a network of five-member rings or six-member rings of carbon. Examples of fullerenes include C₆₀ molecules, C₇₀ molecules, C₇₆ molecules, C₇₈ molecules, C₈₀ molecules, C₈₂ molecules, C₈₄ molecules, C₈₆ molecules, C₈₈ molecules, C₉₀ molecules, C₉₂ molecules, C₉₄ molecules, C₉₆ molecules, etc. C₆₀ molecules and C₇₀ molecules are preferred as fullerene molecules since they easily roll, and as a result a sliding material is obtained that is effective in reducing friction.

A specific example is described below in which the hexagonal crystals are graphite and the ball-shaped molecules are C₆₀ molecules.

FIG. 1 is a structural model showing an example of the sliding material of the present invention. A sliding material 1 is constituted by graphite 2 and C₆₀ molecules 4 that are inserted between graphite layers 3. The structure in which the C₆₀ molecules 4 are inserted between the graphite layers 3 is repeated in plurality in the thickness direction.

The C₆₀ molecules 4 are aligned to form a monolayer between the graphite layers 3. By having the C₆₀ molecules 4 form a monolayer between the graphite layers 3, the molecules easily roll, and as a result a sliding material is obtained that is effective in reducing friction.

It is preferable that the layer formed by the C₆₀ molecules 4 have a dense structure with small gaps between the C₆₀ molecules so as to further facilitate the rolling of the C₆₀ molecules 4. A dense structure specifically means a structure in which the C₆₀ molecules 4 are aligned so that the center-to-center spacing between adjacent C₆₀ molecules 4 and 4 in the planar direction is 1 nanometer.

The distance between the C₆₀ molecules 4 in the thickness direction is preferably 1.4 nanometers or less to ensure a stable structure. The distance between the C₆₀ molecules 4 in the thickness direction is, as shown in FIG. 1, a center-to-center spacing a between C₆₀ molecules 4 and 4 that are adjacent via the graphite layers 3. The lower limit of the center-to-center spacing a is 1.3 nanometers.

The sliding material of the present invention may be mixed with a solid or fluid, and this mixture may be used as the sliding material (solid lubricant or fluid lubricant). A solid that is mixed with the sliding material includes a resin in which the base resin is polystyrene, polyethylene terephthalate, polycarbonate, polyacetal (polyoxymethylene), polyamide, denatured polyphenylene ether, polybutylene terephthalate, polyphenylene sulfide, polyether ether ketone, or polyetherimide. A fluid that is mixed with the sliding material includes lubricating oil such as gear oil, machine oil, bearing oil, and precision instrument oil.

Also, the sliding material of the present invention may be provided on a solid surface, with this solid being used as the sliding material. This sliding material may be a layer of a sliding material that is formed by applying the sliding material on a solid surface, with examples including nickel plating, zinc plating, aluminum plating, copper plating, gold plating, and the like. A solid on whose surface the sliding material is applied includes resins such as polycarbonate and polyacetal, brass, steel, aluminum alloy, copper alloy, magnesium alloy, and the like.

(Method of Manufacture of Sliding Material)

The sliding material of the present invention is produced by a step that widens the interlayer of hexagonal crystals forming a layer structure (hereafter referred to as the expansion step) and a step that inserts ball-shaped molecules in the interlayer of the hexagonal crystals (hereafter referred to as the intercalation step).

The interlayer of the hexagonal crystals is widened by immersing the hexagonal crystals in a liquid mixture of sulfuric acid and nitric acid, drying the hexagonal crystal, and then applying heat. The mixture ratio of the sulfuric acid and nitric acid (sulfuric acid:nitric acid) is preferably 4:1 (volumetric ratio). The concentrations of the sulfuric acid and nitric acid are preferably 100%. The immersion time is preferably 16 to 17 hours, and the temperature of the liquid mixture during immersion is preferably 20° C. to 30° C. Also, the immersion is preferably performed while agitating the liquid mixture and the hexagonal crystals. The heating of the hexagonal crystals after drying is preferably performed at 1000 to 1100° C.

The insertion step is a step that specifically inserts the ball-shaped molecules in the interlayer of the hexagonal crystals widened by the expansion step by sublimating the ball-shaped molecules. Sublimation of the ball-shaped molecules is performed by heating to a temperature at which the ball-shaped molecules sublimate. In the case of the ball-shaped molecules being C₆₀ molecules, heating to 550 to 600° C. is performed. The heating time is preferably 2 to 3 weeks. Also, in order to prevent oxidation of the ball-shaped molecules, the sublimation of the ball-shaped molecules is preferably performed in a vacuum or in an atmosphere of an inert gas such as nitrogen gas or the like.

Moreover, the manufacturing method of the sliding material of the present invention preferably has a step in which the ball-shaped molecules inserted in the interlayer of the hexagonal crystals form a monolayer in each interlayer (hereafter referred to as the monolayering step). When inserting the ball-shaped molecules in the interlayer of the hexagonal crystals by sublimating the ball-shaped molecules, normally since the ball-shaped molecules inserted in the interlayer of the hexagonal crystals are inserted so as form a monolayer in each interlayer, the intercalation step and the monolayering step proceed simultaneously.

(Device)

The device of the present invention has a sliding portion in which at least one member slides with respect to another member, and provides the sliding material of the present invention on the surface of at least one member of the sliding portion.

Examples of the device include a timepiece, a motor, an automobile, a generator, an airplane, a marine vessel, a motorcycle, a camera, a video camera, spectacles, measuring equipment, photographic equipment, sound recording equipment, sound recording and video recording equipment, printing machines, machining equipment, processing machinery, assembly equipment, conveyance equipment, haulage equipment, dispensing equipment (dispenser), and machinery having bearings, and the like.

Examples of the sliding portion of a device include the gear tooth flank of a timepiece, the bearing portion of the gearing of a timepiece, a brush of a motor, a stator, a rotor, a car motor piston, the turbine bearing portion of a generator, a camera shutter, spectacle frames, and the like.

(Timepiece)

A timepiece that is an example of a device of the present invention includes one having at least one set of gears for transmitting power and a changeover mechanism that corrects the time.

The gears and the changeover mechanism have a sliding portion in which at least one member slides with respect to another member, with the sliding material of the present invention provided on the surface of at least the one member of the sliding portion.

The sliding material of the present invention as explained above is based on slippage within a solid, unlike conventional material for improving friction characteristics by improvements to the solid surface. That is, when shearing force is applied to a hexagonal crystal in the state of ball-shaped molecules inserted in the interlayers of hexagonal crystals forming a layer structure, the ball-shaped molecules roll in the interlayers of the hexagonal crystals, whereby fluctuations are caused and super lubrication is brought about in which the friction is extremely close to zero. The structure in which ball-shaped molecules are inserted in the interlayers of the hexagonal crystals exists in unlimited repetition in the thickness direction in the sliding material of the present invention. Therefore, in the sliding material of the present invention, super lubrication is brought about in which the friction approximates zero by in-solid slipping that utilizes the slip surface (the interfacial boundary of the hexagonal crystal layer and the layer of ball-shaped molecules) that exists in unlimited repetition in the thickness direction in the sliding material of the present invention.

Since the sliding material of the present invention utilizes in-solid slipping, the effect of water and effects due to surface abrasion, etc. can be disregarded, and the durability is excellent. Also, since there is no anisotropy on the sliding surface, there is no anisotropy in the frictional force as well, leading to free sliding in all directions within the plane.

Also, by using hexagonal crystals with nanometer- or micrometer-size thicknesses, the obtained sliding material can be applied to tiny machinery such as nanomachines and micromachines. By using powdered hexagonal crystals, the obtained sliding material can be used as a lubricant for roller bearings and the like in conventional machinery.

### EXAMPLES

Examples are illustrated below.

### Example 1

First, 100% sulfuric acid and 100% nitric acid were mixed at a ratio of sulfuric acid:nitric acid=4:1 (volume ratio), and Highly Oriented Pyrolytic Graphite (HOPG) (available from Veeco, Grade-ZYH) measuring 2.2 mm×2.2 mm×0.2 mm was put into 50 ml of the liquid mixture, and the mixture was then agitated for 16 hours at 20° C. using a stirrer 11 as shown in FIG. 2. A HOPG 12 was removed, washed with pure water and then neutralized with acid.

As shown in FIG. 3, the HOPG 12 was placed in a furnace 13 and heated for 1 to 2 minutes at 100° C. to completely evaporate the moisture of the HOPG 12, and then additionally heated for 15 seconds at 1050° C. to widen the interlayer space of the HOPG 12.

Subsequently, 7.54 mg of C₆₀ molecules (made by MTR with a purity of 99.98% or greater) and 3.77 mg of interlayer-widened HOPG was put in a quartz tube, which was sealed after being evacuated.

As shown in FIG. 4, a quartz tube 14 in which C₆₀ molecules and HOPG were sealed was placed in the furnace 13 and heated for two weeks at 600° C. to insert sublimated C₆₀ molecules into the HOPG interlayers. By doing so, a 2.2 mm×2.2 mm×0.2 mm sliding material was obtained as shown in FIG. 5.

The structure of the obtained sliding material was confirmed using a high-resolution electron microscope (made by JEOL, model JEM-2000EX). A high-resolution electron microscope image is shown in FIG. 6, and the diffraction pattern is shown in FIG. 7. Also the structural model to be obtained is shown in FIG. 1.

The friction characteristics of the obtained sliding material were investigated using a frictional force microscope (made by Seiko Instruments Inc., model SPI300). Specifically, a probe was made to travel back and forth over the sliding material surface while applying a fixed load, at which time the frictional force was measured. The result of load 0 nN is shown in FIG. 8, the result of load 10 nN is shown in FIG. 9, the result of load 20 nN is shown in FIG. 10, the result of load 60 nN is shown in FIG. 11, the result of load 100 nN is shown in FIG. 12, and the result of load 10 μN is shown in FIG. 13. In the results of FIGS. 8 to 13, the frictional force was extremely close to zero within the range of the limit of measurement of the frictional force microscope (the frictional force being 0.1 nN).

From the result of FIGS. 8 to 13, the state in which the static friction force and the dynamic friction force approach zero is realized at a load of 100 nN. Also, no anisotropy of the frictional force was observed.

### Second Example

An example is now explained that provides the sliding material of the first example in the sliding portion of an analog timepiece.

(Structure of Analog Timepiece)

The movement (machinery) of the analog timepiece used in the second example shall be explained first referring to FIGS. 14 to 17.

A movement (machinery) 100 of an analog timepiece is provided with a support member of the movement 100 constituted from a main plate 102, a train wheel bridge 112, and a second wheel bridge 114; a winding stem 110 that is incorporated so as to be pivotable in a winding stem guide hole of the main plate 102; an insulating plate 160; a switch spring 162; a circuit block 116 that is fixed to the main plate 102 and the train wheel bridge 112 by the switch spring 162 through the insulating plate 160; a battery 120 that constitutes the power source of the analog timepiece; an IC 118 and a crystal oscillator 122 that are attached to the circuit block 116; a changeover spring 166 for determining the position of the axial direction of the winding stem 110 that is integrally formed with the switch spring 162; an hour motor 210 constituted from a coil block A212, a stator A214, and an hour rotor 216; an hour display wheel train constituted from an intermediate minute wheel 222, a minute wheel 224, and an hour wheel 226; a minute motor 240 constituted from a coil block B242, a stator B244, and a minute rotor 246; a minute display wheel train constituted from a second intermediate wheel B252, a second intermediate wheel A254, and a minute wheel 256; a second motor 270 constituted from a coil block C272, a stator C274, and a second rotor 276; and a second display wheel train constituted from a fifth wheel 282 and a second wheel 284.

The movement (machinery) 100 is constituted so as to show the “hour” of the present time with an hour hand 230 by rotation of the hour display wheel train from rotation of the hour motor 210. It is also constituted so as to show the “minute” of the present time with a minute hand 260 by rotation of the minute display wheel train from rotation of the minute motor 240. It is also constituted so as to show the “second” of the present time with a second hand 290 by rotation of the second display wheel train from rotation of the second motor 270.

A rechargeable secondary battery can be used as the battery 120, and a rechargeable capacitor can also be used. The crystal oscillator 122 constitutes the source oscillation of the analog timepiece, and oscillates at, for example, 32, 768 Hertz.

(Placement of Sliding Material)

In the movement (machinery) 100, the sliding material of the first example was provided as follows in the bearing portion of the second motor 270 (the upper bearing portion constituted from the second motor bearing portion 276a and the train wheel bridge 112, and the lower bearing portion constituted from the second motor bearing portion 276b and the main plate 102).

First, a portion of the sliding material obtained in the first example was separated to obtain a sliding material with a thickness of 1 μm.

An epoxy-based adhesive was applied at a thickness of 0.1 μm on the second motor bearing portion 276a and a portion of the train wheel bridge 112 in contact with the second motor bearing portion 276a. Simultaneously, an epoxy-based adhesive was applied to the second motor bearing portion 276b and a portion of the main plate 102 in contact with the second motor bearing portion 276b.

Then, the separated sliding material was attached to the applied epoxy-based adhesive, and the epoxy-based adhesive was sufficiently dried by being left to stand for one hour at 25° C.

Similarly, the sliding material of the first example was also provided in the bearing portions of the hour motor 210, the hour display wheel train, the minute motor 240, the minute display wheel train, and the second display wheel train. As a result, since friction loss of the sliding portion could be reduced, the battery life could be extended.

### Third Example

In the movement (machinery) 100, the sliding material of the first example was provided as follows in the bearing portion of the second motor 270 (the upper bearing portion constituted from the second motor bearing portion 276a and the train wheel bridge 112, and the lower bearing portion constituted from the second motor bearing portion 276b and the main plate 102).

First, the sliding material obtained in the first example was ground to a particle diameter of 0.1 to 1 μm. Then a lubricant for clocks (SYNTHETIC OIL 9010 (made by MOEBIUS)) and the ground-up sliding material were mixed at a ratio of 10 parts sliding material to 100 parts lubricant.

The lubricant mixed with the sliding material was applied on the second motor bearing portion 276a and a portion of the train wheel bridge 112 in contact with the second motor bearing portion 276a. Simultaneously, the lubricant mixed with the sliding material was applied to the second motor bearing portion 276b and a portion of the main plate 102 in contact with the second motor bearing portion 276b.

Similarly, the sliding material of the first example was also provided in the bearing portions of the hour motor 210, the hour display wheel train, the minute motor 240, the minute display wheel train, and the second display wheel train. As a result, since friction loss of the sliding portion could be reduced, the battery life could be extended.

### Fourth Example

Explained below is an example that provides the sliding material of the first example in the sliding portions of a mechanical timepiece in which a main spring serves as the power source.

(Structure of Mechanical Timepiece)

First, the movement (machinery) of the mechanical timepiece used in the fourth example shall be explained first referring to FIGS. 18 to 21.

The movement (machinery) 300 of the mechanical timepiece has a main plate 302 that constitutes a base plate of the movement. A winding stem 310 is incorporated so as to be pivotable in a winding stem guide hole 302a of the main plate 302. Normally, among the two sides of the main plate, the dial plate-side thereof is referred to as the “back side” of the movement, and the side opposite the dial plate side is referred to as the “front side” of the movement. The wheel train incorporated in the “front side” of the movement is referred to as the “outside wheel train”, and wheel train incorporated in the “back side” of the movement is referred to as the “backside wheel train”. The position in the axial direction of the winding stem 310 is determined by a changeover device that includes a setting lever 390, a yoke 392, a latch spring 394, and a yoke friction spring 396. A winding pinion 312 is rotatably provided in a guide shaft portion of the winding stem 310.

A clutch wheel 398 is disposed so as to be coaxial with the winding stem 310 with respect to the angle portion of the winding stem 310. When the winding stem 310 is rotated to the state of being in a first winding stem position (zeroth step) that is nearest to the inside of the movement along the axis of rotation, the winding pinion 312 is constituted to turn via rotation of the clutch wheel 398. A crown wheel 314 is constituted so as to rotate by rotation of the winding pinion 312. A ratchet wheel 316 rotates by rotation of the crown wheel 314. Rotation of the ratchet wheel 316 winds up the main spring 322 housed in a barrel wheel 320. A center wheel 324 is constituted so as to rotate by rotation of the barrel wheel 320. An escapement wheel 330 rotates through rotation of a fourth wheel 328, a third wheel 326, and the center wheel 324. The barrel wheel 320, the center wheel 324, the third wheel 326, and the fourth wheel 328 constitute the outside wheel train.

A setting wheel 397 is rotatably disposed with respect to the main plate 302. A minute wheel 358 is rotatably disposed with respect to the main plate 302. The gear portion of the setting wheel 397 is constituted to mesh with the gear portion of the minute gearing of the minute wheel 358. The gear portion of the minute gearing of the minute wheel 358 is constituted so as to mesh with the gear portion of a cannon pinion 350. The pinion portion of the minute pinion of the minute wheel 358 is constituted to mesh with the gear portion of a cylinder wheel 354. A minute pusher 384 supports the setting wheel 397 and the minute wheel 358 so as to be rotatable with respect to the main plate 302. When the winding stem 310 is rotated to the state of being in a second winding stem position (first step) on the outside of the movement along the axis of rotation, the setting wheel 397 is constituted to rotate by rotation of the clutch wheel 398. Moreover, when the winding stem 310 is rotated to the state of being in the first step, the minute wheel 358 is constituted to rotate by rotation of the setting wheel 397. In this state, when the minute wheel 358 rotates, the cannon pinion 350 and the cylinder wheel 354 rotate, and accordingly an hour hand 356 and a minute hand 352 rotate, so that time correction of the timepiece can be performed.

An escapement/controller that controls the rotation of the outside wheel train includes a balance 340, an escapement wheel 330, and an pallet fork 342. The balance 340 includes a balance staff 340a, a balance wheel and balance spring 340c. Based on rotation of the center wheel 324, the cannon pinion 350 rotates simultaneously. The minute hand 352 attached to the cannon pinion 350 shows “minutes”. A slip mechanism with respect to the center wheel 324 is provided in the cannon pinion 350. Based on rotation of the cannon pinion 350, the cylinder wheel 354 rotates via rotation of the minute wheel 358. The hour hand 356 attached to the cylinder wheel 354 shows the “hour”. The balance spring 340c is a flat spring with a swirling (spiral) shape having a plurality of windings. The inner end portion of the balance spring 340c is fixed to a collet 340d that is fixed to the balance staff 340a, and the outer end portion of the balance spring 340c is fixed by a screw fastening through a stud 370a that is attached to a stud support 370 that is fixed to a balance bridge 366. A regulator pin 368 is rotatably attached to the balance bridge 366. The balance 340 is supported so as to be rotatable with respect to the main plate 302 and the balance bridge 366.

The barrel wheel 320 is provided with a barrel drum 320d, a barrel arbor 320f, and a main spring 322. The barrel arbor 320f includes an upper shaft 320a and a lower shaft 320b. The barrel arbor 320f is formed with a metal such as carbon steel. The barrel drum 320d is formed with a metal such as brass. The center wheel 324 includes an upper shaft 324a, a lower shaft 324b, a pinion portion 324c, a gearwheel portion 324d, and a bead portion 324h. The pinion portion 324c of the center wheel 324 is constituted so as to mesh with the barrel drum 320d. The upper shaft 324a, the lower shaft 324b, and the bead portion 324b are formed with a metal such as carbon steel. The gearwheel portion 324d is formed with a metal such as brass. The third wheel 326 includes an upper shaft 326a, a lower shaft 326b, a pinion portion 326c, and a gearwheel portion 326d. The pinion portion 326c of the third wheel 326 is constituted so as to mesh with the gearwheel portion 324d. The fourth wheel 328 includes an upper shaft 328a, a lower shaft 328b, a pinion portion 328c, and a gearwheel portion 328d. The upper shaft 328a and the lower shaft 328b are formed with a metal such as carbon steel. The gearwheel portion 328d is formed with a metal such as brass. The escapement wheel 330 includes an upper shaft 330a, a lower shaft 330b, a pinion portion 330c, and a gearwheel portion 330d. The pinion portion 330c of the escapement wheel 330 is constituted so as to mesh with the gearwheel portion 328d. The gearwheel portion 328d of the escapement wheel 330 is constituted so as to mesh with a pallet stone 343 that is bonded to the pallet fork 342. The pallet fork 342 is provided with an pallet fork (incomplete) 342d and an pallet staff 342f. The pallet staff 342f includes an upper shaft 342a and a lower shaft 342b.

The barrel wheel 320 is supported so as to be rotatable with respect to the main plate 302 and a barrel bridge 360. That is, the upper shaft 320a of the barrel arbor 320f is supported so as to be rotatable with respect to the barrel bridge 360. The lower shaft 320b of the barrel arbor 320f is supported so as to be rotatable with respect to the main plate 302. The center wheel 324, the third wheel 326, the fourth wheel 328, and the escapement wheel 330 are supported so as to be rotatable with respect to the main plate 302 and a train wheel bridge 362. That is, the upper shaft 324a of the center wheel 324, the upper shaft 326a of the third wheel 326, the upper shaft 328a of the fourth wheel 328, and the upper shaft 330a of the escapement wheel 330 are supported so as to be rotatable with respect to the train wheel bridge 362. Also, the lower shaft 324b of the center wheel 324, the lower shaft 326b of the third wheel 326, the lower shaft 328b of the fourth wheel 328, and the lower shaft 330b of the escapement wheel 330 are supported so as to be rotatable with respect to the main plate 302. The pallet fork 342 is supported so as to be rotatable with respect to the main plate 302 and an pallet fork bearing 364. That is, the upper shaft 342a of the pallet fork 342 is supported so as to be rotatable with respect to the pallet fork bearing 364. The lower shaft 342b of the pallet fork 342 is rotatably supported with respect to the main plate 302.

(Placement of Sliding Material)

In the movement (machinery) 300, the sliding material of the first example was provided as follows in the sliding portion with the escapement wheel 330 (the gearwheel portion 330d) and the pallet stone 343.

First, a portion of the sliding material obtained in the first example was separated to obtain a sliding material with a thickness of 1 μm.

An epoxy-based adhesive was applied at a thickness of 0.1 μm on the gearwheel portion 330d of the escape wheel 330 and the pallet stone 343.

Then, the separated sliding material was attached to the applied epoxy-based adhesive, and the epoxy-based adhesive was sufficiently dried by being left to stand for one hour at 25° C.

Similarly, the sliding material of the first example was also provided in the bearing portions of the center wheel 324, the third wheel 326, the fourth wheel 328, the balance staff 340a and the changeover wheel. As a result, since friction loss of the sliding portion could be reduced, the duration of the main spring could be extended.

### Fifth Example

In the movement (machinery) 300, the sliding material of the first example was provided as follows in the sliding portion with escape wheel 330 (the gearwheel portion 330d) and the pallet stone 343.

First, the sliding material obtained in the first example was ground to a particle diameter of 0.1 to 1 μm. Then a lubricant for timepieces (SYNTHETIC OIL 9010 (made by MOEBIUS)) and the ground-up sliding material were mixed at a ratio of 10 parts sliding material to 100 parts lubricant.

The lubricant mixed with the sliding material was applied on the gearwheel portion 330d of the escapement wheel 330 and the pallet stone 343.

Similarly, the sliding material of the first example was also provided in the bearing portions of the center wheel 324, the third wheel 326, the fourth wheel 328, the balance staff 340a and the changeover wheel. As a result, since friction loss of the sliding portion could be reduced, the duration of the main spring could be extended.

### INDUSTRIAL APPLICABILITY

The sliding material of the present invention can be used in machines/devices of various sizes ranging from heavy machinery such as automobiles to nanomachines without restrictions on the environment it can be used, can minimize friction compared to conventional types, and has superior durability.

### BRIEF DESCRIPTION OF THE DRAWINGS

FIG. 1 is a structural model showing an example of a sliding material of the present invention.

FIG. 2 is a drawing showing one manufacturing step of the sliding material of the example.

FIG. 3 is a drawing showing one manufacturing step of the sliding material of the example.

FIG. 4 is a drawing showing one manufacturing step of the sliding material of the example.

FIG. 5 is a photograph and a schematic view of the sliding material obtained in the example.

FIG. 6 is a high-resolution electron microscope image of the sliding material obtained in the example.

FIG. 7 is a diffraction pattern of the sliding material obtained in the example.

FIG. 8 is a graph showing the frictional characteristics (load 0 nN) of the sliding material obtained in the example.

FIG. 9 is a graph showing the frictional characteristics (load 10 nN) of the sliding material obtained in the example.

FIG. 10 is a graph showing the frictional characteristics (load 20 nN) of the sliding material obtained in the example.

FIG. 11 is a graph showing the frictional characteristics (load 60 nN) of the sliding material obtained in the example.

FIG. 12 is a graph showing the frictional characteristics (load 100 nN) of the sliding material obtained in the example.

FIG. 13 is a graph showing the frictional characteristics (load 10 μN) of the sliding material obtained in the example.

FIG. 14 is a plan view showing the outline shape of the movement in the example of an analog timepiece of the present invention, seen from the front.

FIG. 15 is an outline partial sectional view showing the portion of the second hand from the second motor in the example of an analog timepiece of the present invention.

FIG. 16 is an outline partial sectional view showing the portion of the minute hand from the minute motor in the example of an analog timepiece of the present invention.

FIG. 17 is an outline partial sectional view showing the portion of the second hand from the second motor in the example of an analog timepiece of the present invention.

FIG. 18 is a plan view showing the outline shape of the front of the movement in the example of the mechanical timepiece of the present invention.

FIG. 19 is an outline partial sectional view of the example of the mechanical timepiece of the present invention, showing a portion of the pallet fork from the barrel.

FIG. 20 is an outline partial sectional view of the example of the mechanical timepiece of the present invention, showing a portion of the balance from the escapement wheel.

FIG. 21 is an outline partial sectional view of the example of the mechanical timepiece of the present invention, showing a portion of the winding stem, the setting wheel, and the minute wheel.

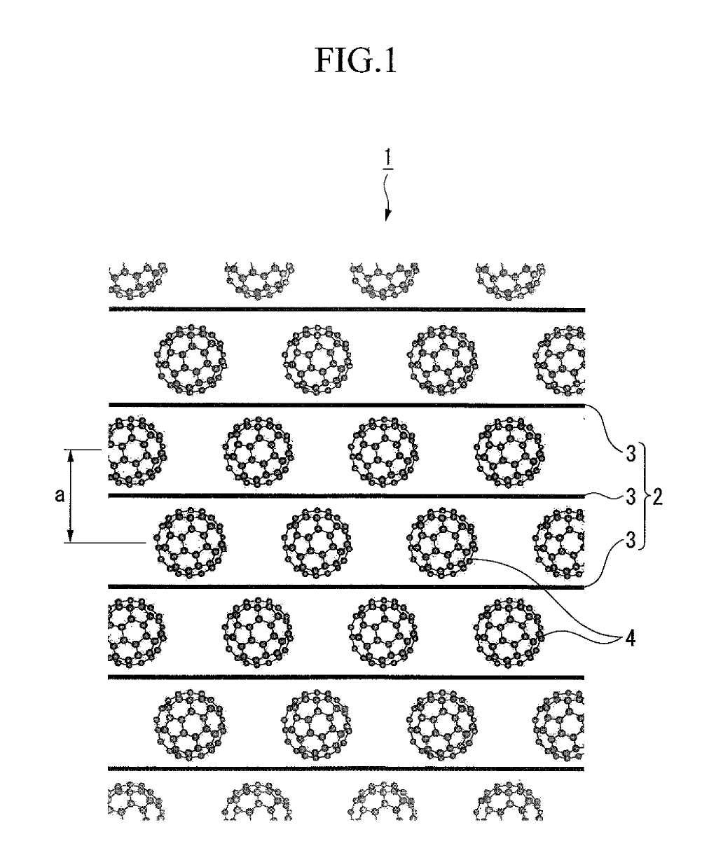

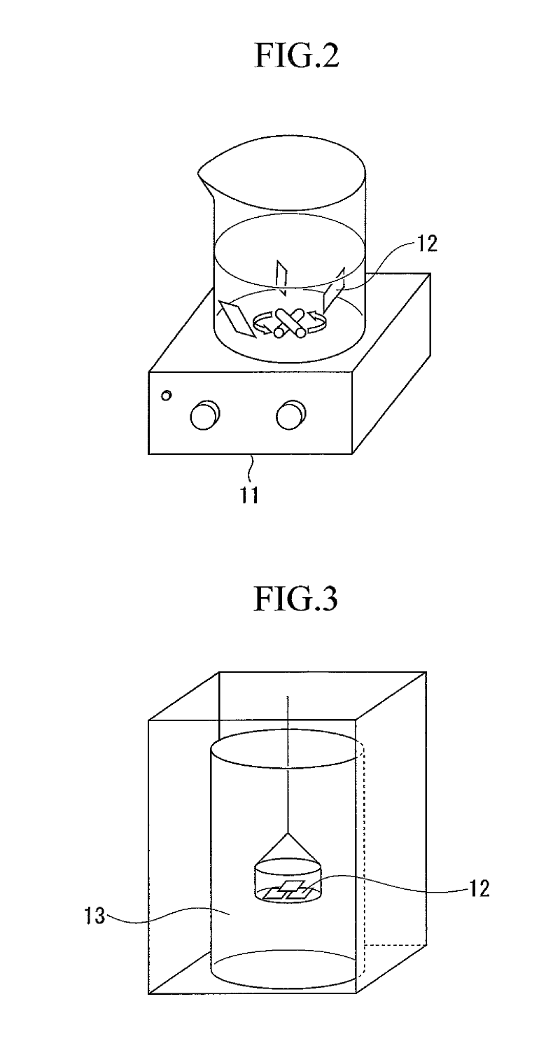

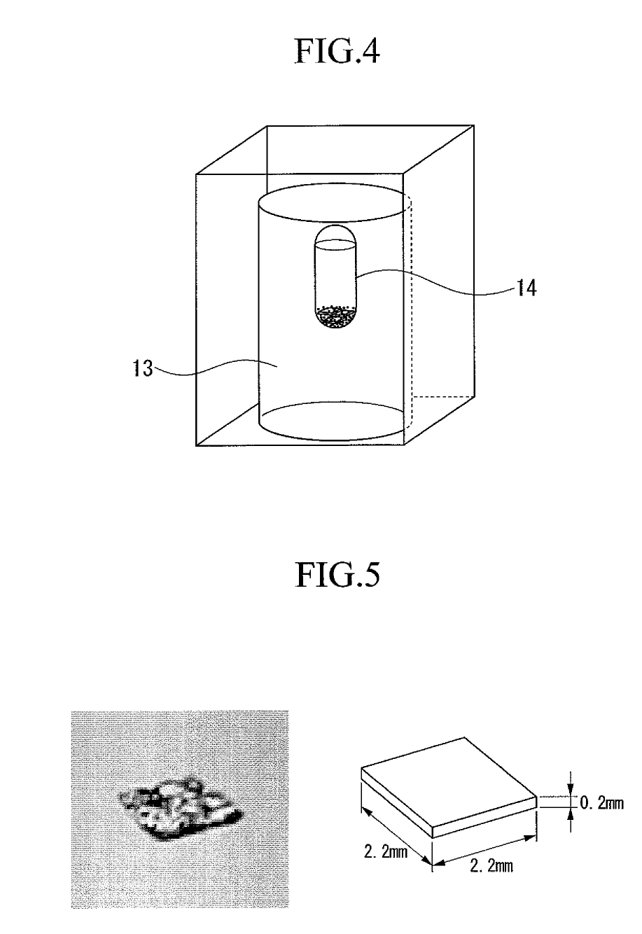

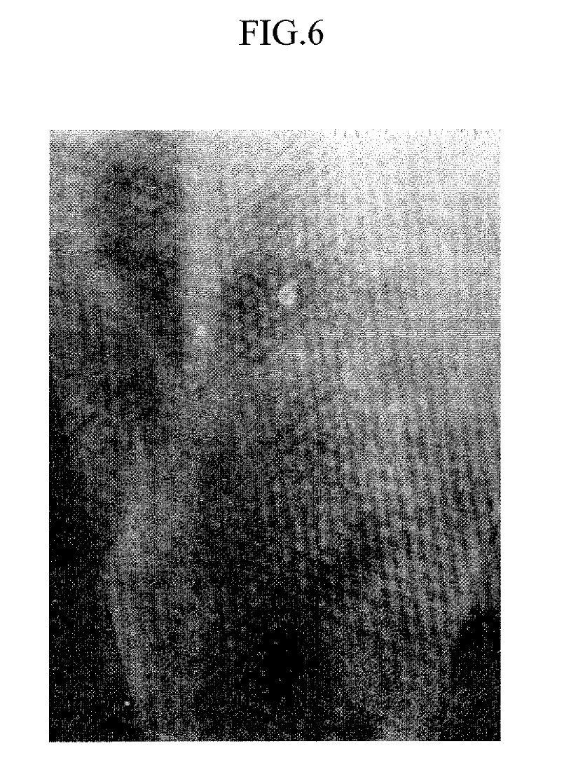

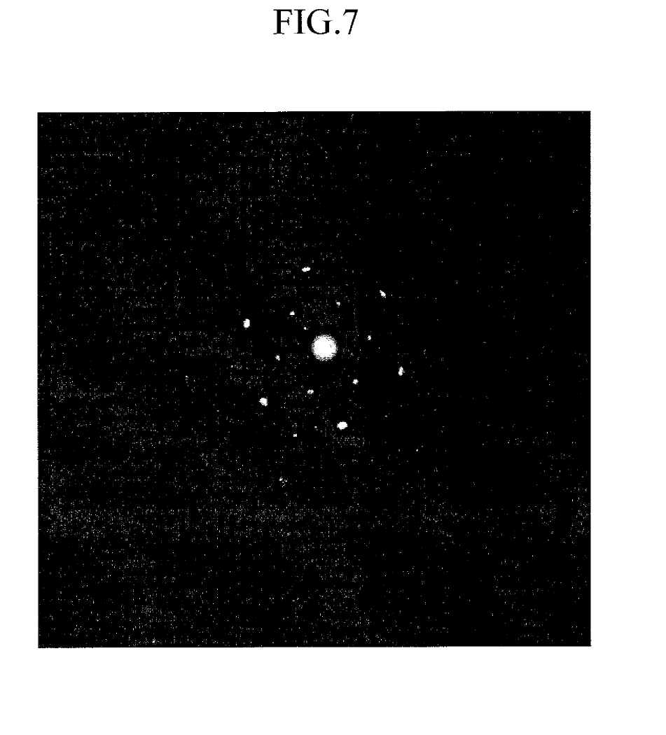

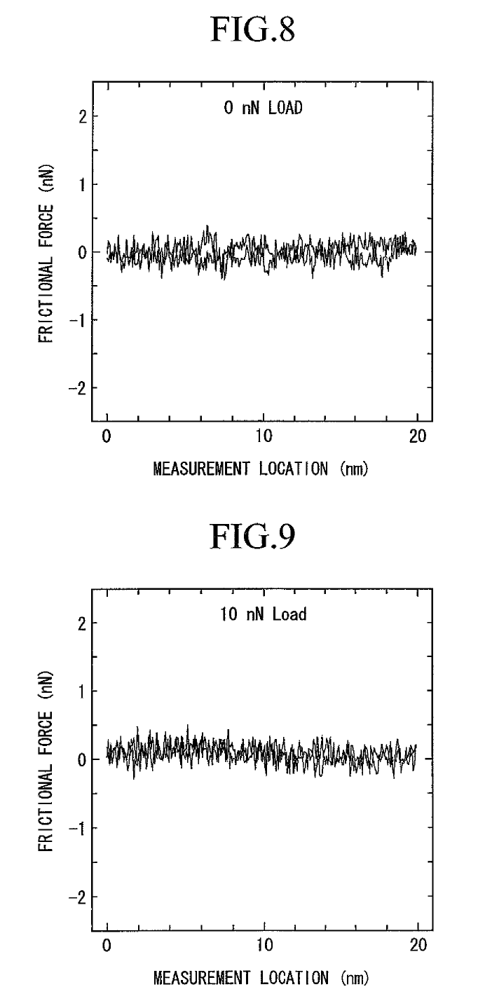

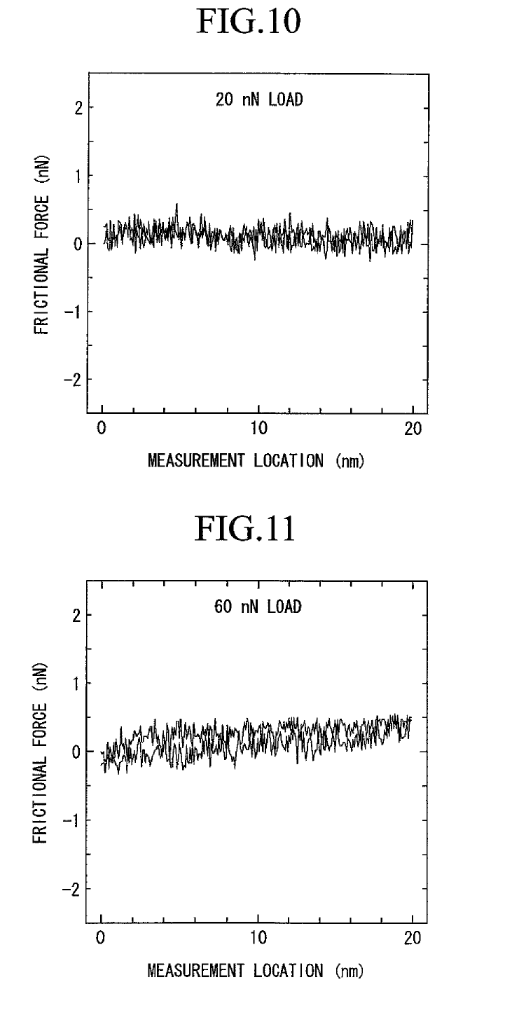

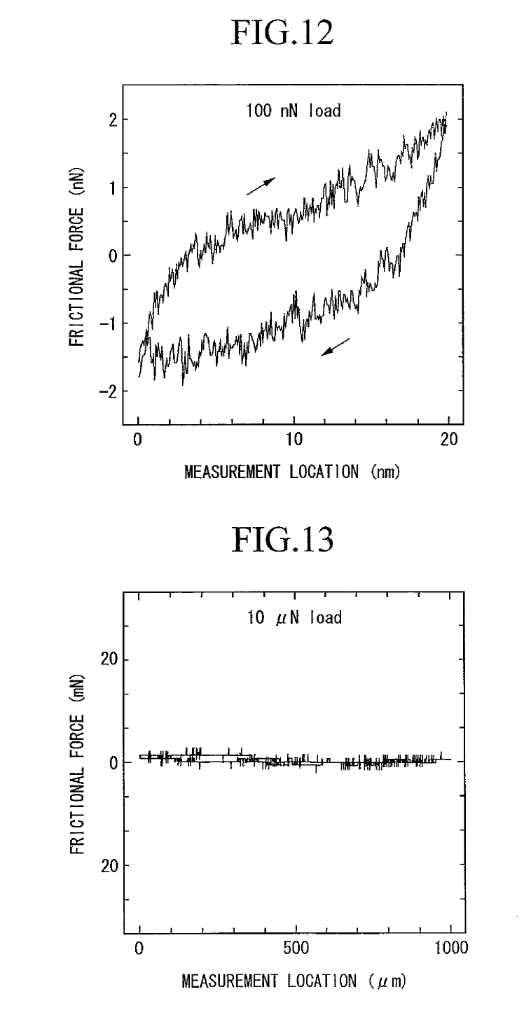

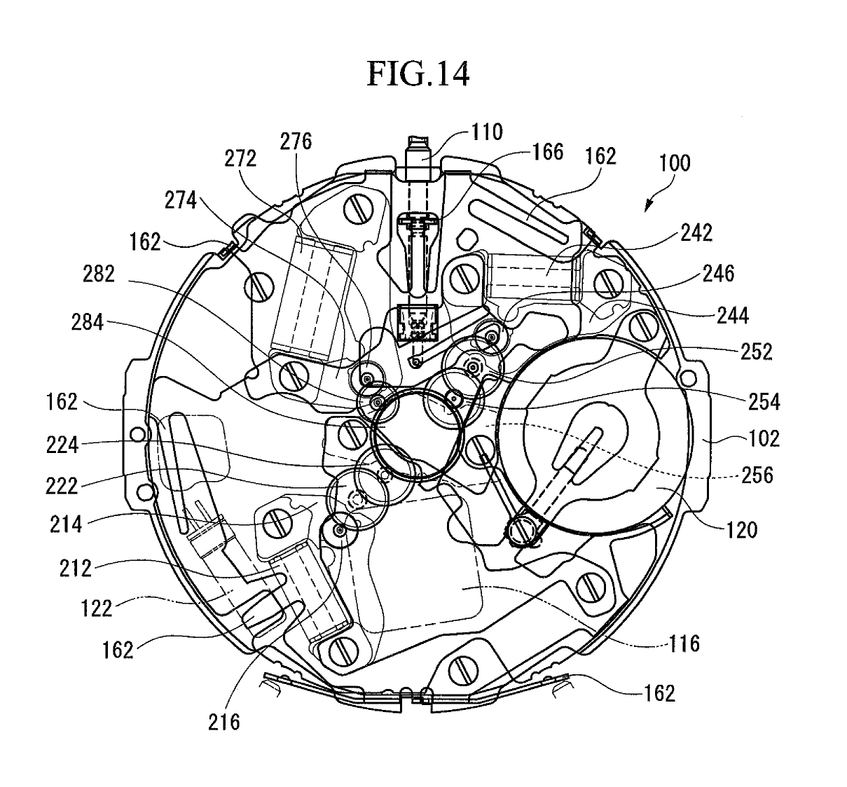

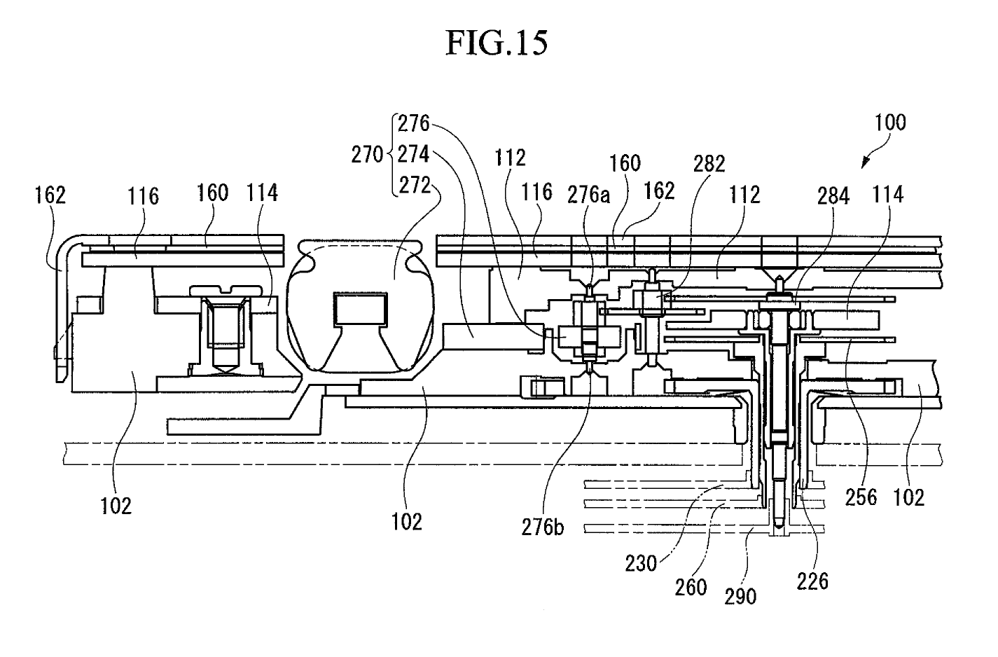

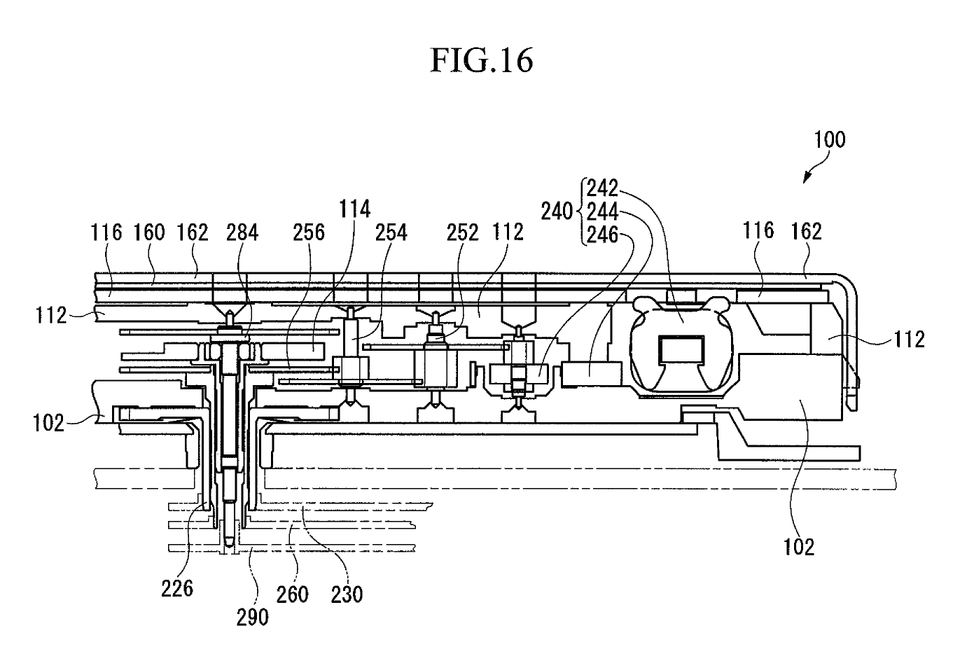

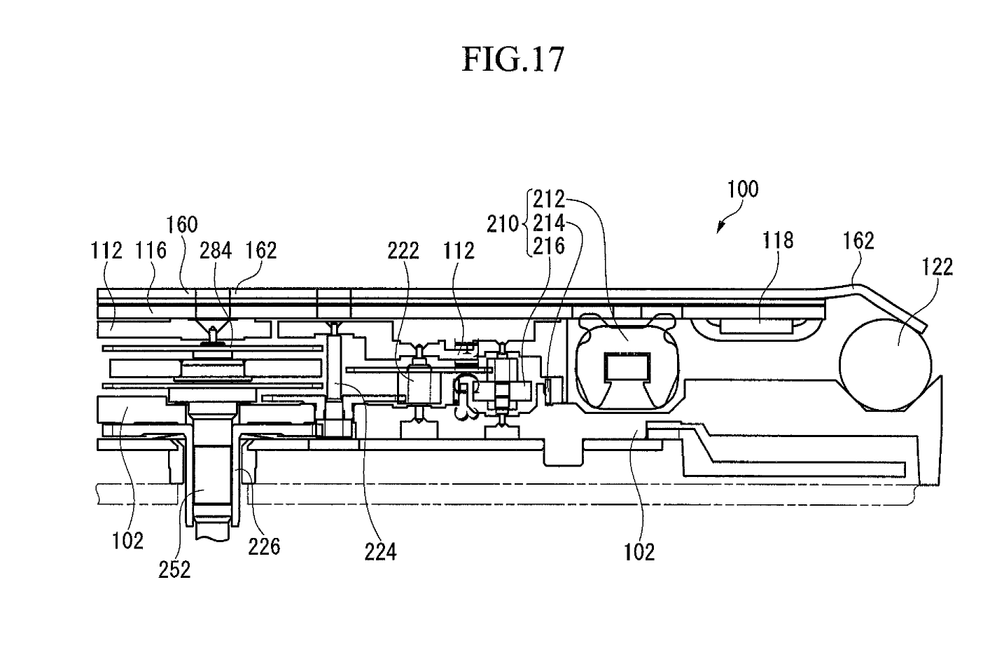

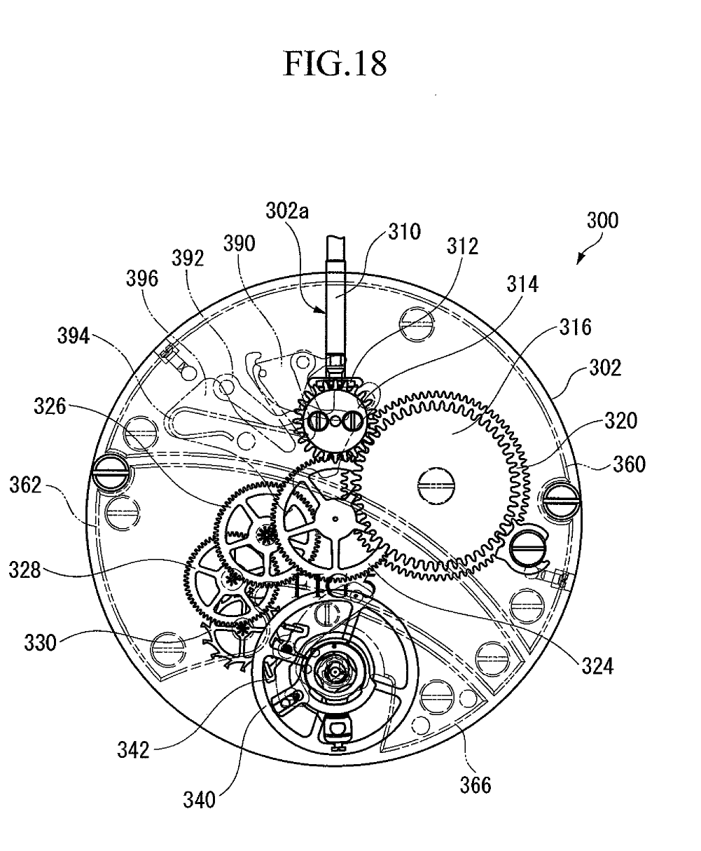

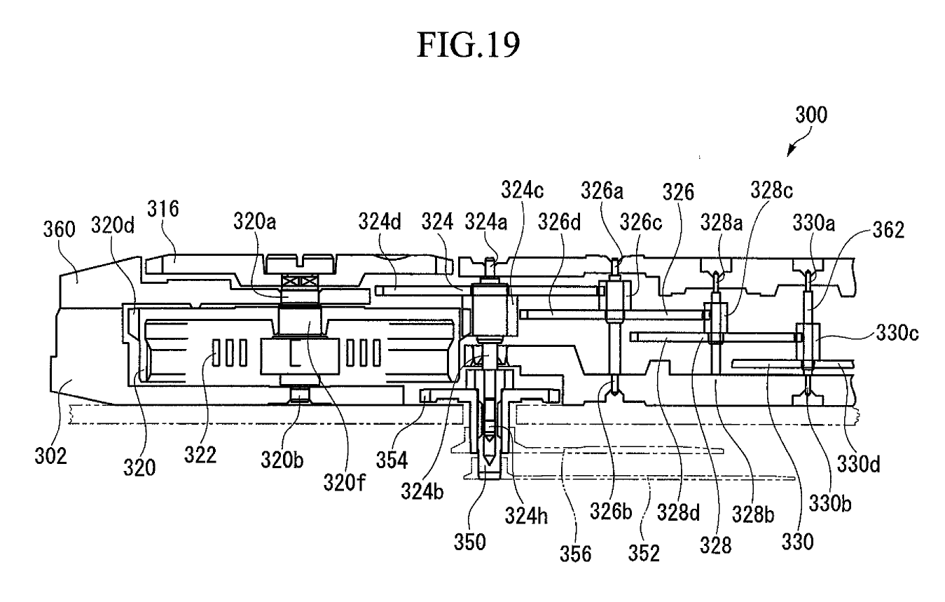

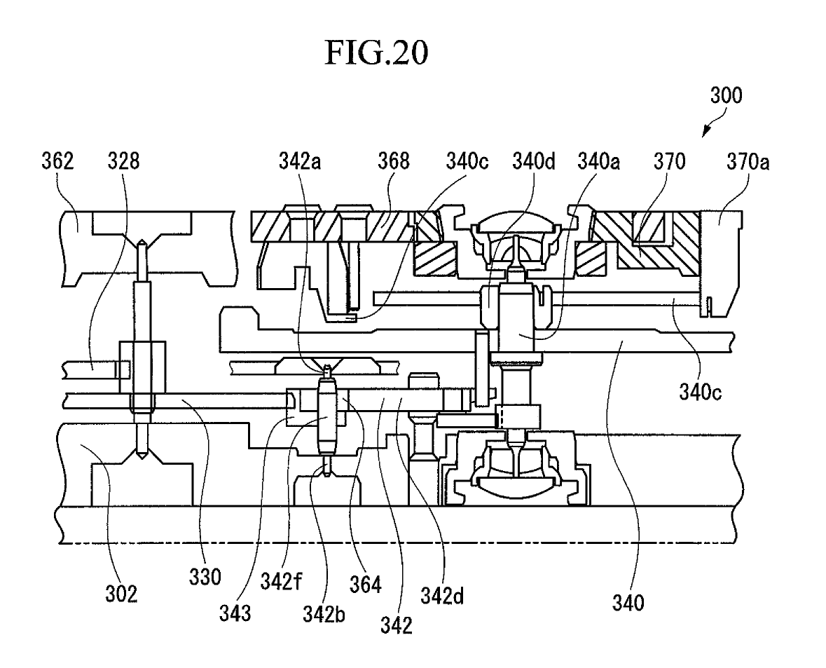

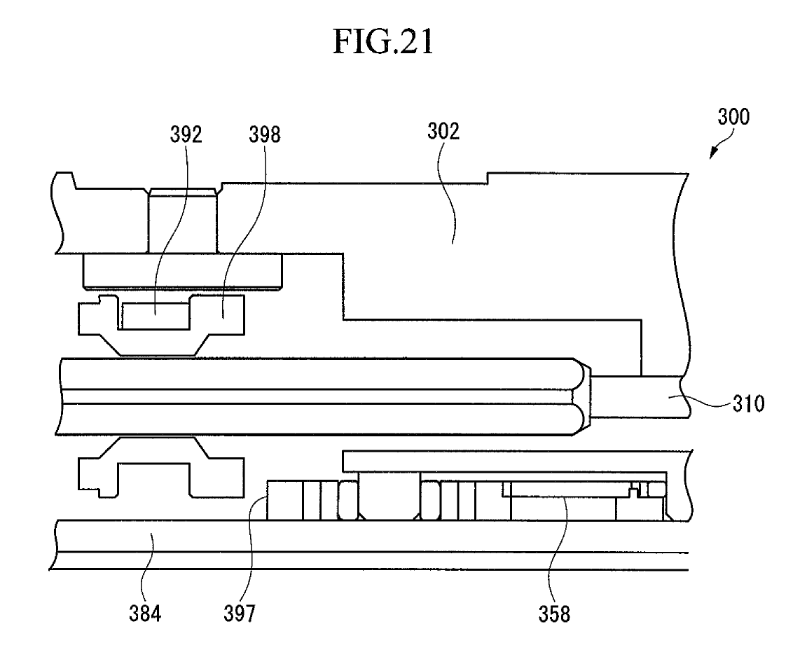

### EXPLANATION OF SYMBOLS

1 sliding material
2 graphite
3 graphite layer
4 C₆₀ molecule
11 stirrer
12 HOPG
13 furnace
14 quartz tube
100 movement (machinery)
102 main plate
110 winding stem
112 train wheel bridge
114 second bridge
116 circuit block
118 IC
120 battery
122 crystal oscillator
160 insulating plate
162 switch spring
166 changeover spring
210 hour motor
212 coil block
214 stator
216 hour rotor
222 intermediate minute wheel
224 minute wheel
226 hour wheel
230 hour hand
240 minute motor
242 coil block B
244 stator B
246 minute rotor
252 second intermediate wheel B
254 second intermediate wheel A
256 minute wheel
260 minute hand
270 second motor
272 coil block C
274 stator C
276 second rotor
276a second motor bearing portion
276b second motor bearing portion
282 fifth wheel
284 second wheel
300 movement (machinery)
302 main plate
302a winding stem guide hole
310 winding stem
312 winding pinion
314 crown wheel
316 ratchet wheel
320 barrel wheel
320a upper shaft
320b lower shaft
320d barrel drum
320f barrel arbor
322 main spring
324 center wheel
324a upper shaft
324b lower shaft
324c pinion portion
324d gearwheel portion
324h bead portion
326 third wheel
326a upper shaft
326b lower shaft
326c pinion portion
326d gearwheel portion
328 fourth wheel
328a upper shaft
328b lower shaft
328c pinion portion
328d gearwheel portion
330 escapement wheel
330d gearwheel portion
340 balance
340a balance staff
340c balance spring
340d collet
342 pallet fork
342a upper shaft
342b lower shaft
342d pallet fork (incomplete)
342f pallet staff
350 cannon pinion
352 minute hand
354 cylinder wheel
356 hour hand
358 minute wheel
360 barrel bridge
362 train wheel bridge
364 pallet fork bearing
366 balance bridge
368 regulator pin
370 stud support
370a stud
384 minute pusher
390 setting lever
392 latch
394 latch spring
396 yoke friction spring
397 setting wheel
398 clutch wheel

What is claimed is:

1. A sliding material comprising:
hexagonal crystals that form a layer structure, and
ball-shaped molecules inserted in interlayers of the hexagonal crystals.

2. A sliding material according to claim 1, wherein the structure in which the ball-shaped molecules are inserted in interlayers of the hexagonal crystals exists in plurality repetition in the thickness direction.

3. A sliding material according to claim 1, wherein the ball-shaped molecules form a monolayer in each interlayer of the hexagonal crystals.

4. A sliding material according to claim 2, wherein the distance between the ball-shaped molecules in the thickness direction is 1.4 nanometers or less.

5. A sliding material according to claim 3, wherein the distance between the ball-shaped molecules in the thickness direction is 1.4 nanometers or less.

6. A sliding material according to claim 1, wherein the ball-shaped molecules have five-member rings or six-member rings of carbon.

7. A sliding material according to claim 1 further comprising a solid or fluid.

8. A sliding material wherein the sliding material recited in claim 1 is provided on a solid surface.

9. A method of manufacturing a sliding material comprising:
widening the interlayer of hexagonal crystals forming a layer structure; and
inserting ball-shaped molecules in the interlayer of the hexagonal crystals.

10. A method of manufacturing a sliding material recited in claim 9, wherein the ball-shaped molecules are inserted in the interlayer of the hexagonal crystals by sublimating the ball-shaped molecules.

11. A device comprising:
a sliding portion in which at least one member slides with respect to another member, and
being provided with the sliding material recited in claim 1 on the surface of at least one member of the sliding portion.

12. A timepiece comprising:
at least one gear set that transmits power and a changeover mechanism that corrects the time,
wherein the gear set and/or the changeover mechanism have/has a sliding portion in which at least one member slides with respect to another member, and
the sliding material recited in claim 1 is provided on the surface of at least one member of the sliding portion.

13. (canceled)
